(19) United States
(12) Patent Application Publication
(10) Pub. No.: US 2015/0069034 A1
(43) Pub. Date: Mar. 12, 2015

(54) BUILT IN GRINDER

(71) Applicant: Lincoln Global, Inc., City of Industry, CA (US)

(72) Inventor: BRYAN SCOTT BURKHART, CHARDON, OH (US)

(73) Assignee: Lincoln Global, Inc., City of Industry, CA (US)

(21) Appl. No.: 14/104,140

(22) Filed: Dec. 12, 2013

Related U.S. Application Data
(60) Provisional application No. 61/876,807, filed on Sep. 12, 2013.

(51) Int. Cl. B23K 9/32; B23K 37/02; B23K 37/08; B23K 9/10

(52) U.S. Cl. CPC B23K 9/32; B23K 9/1006; B23K 37/0294; B23K 37/08
USPC 219/133

(57) ABSTRACT

The invention described herein generally pertains to an apparatus for a welding operation having peripheral attachments combined with welding capability. Particularly, various welders can include powered tools integrated into the welder to expedite welding operations while increasing equipment convenience, reliability, and survivability. In embodiments, a grinder can be built into a welder. In embodiments the welder can be an engine driven welder or hybrid welder.

### CROSS-REFERENCE TO RELATED APPLICATIONS AND INCORPORATION BY REFERENCE

This U.S. patent application is a continuation of and claims the benefit of U.S. provisional patent application 61/876,807 filed on Sep. 12, 2013, which is incorporated herein by reference in its entirety.

### TECHNICAL FIELD

Devices, systems, and methods consistent with the invention relate generally to welding equipment, and more particularly, to combining multiple pieces of welding equipment, and still more particularly to integrating a grinder or other corded accessories with a welding machine.

### BACKGROUND OF THE INVENTION

Welding operations are frequently performed with more than a single tool connected to a power supply. In addition to multiple torches or power supplies, a variety of powered and unpowered tools are used to prepare for a future welding operation, guide or improve an ongoing welding operation, or fix or finish a completed welding operation.

Further, welding operations are frequently conducted under mobile conditions. Worksites change, and entire classes of welders are dedicated to vehicle support or vehicle mounting. Some such welders include engine driven welders. Other welders include battery-powered welders or hybrid welders that utilize multiple sources of power.

Despite these advances, mobile conditions present a variety of challenges. First, the correct tools must be present at a jobsite. The tools available must also be electrically compatible with power supplies on the jobsite. Electrical compatibility can be influenced by, for example, signal frequency, noise, ground fault circuit interruptor requirements, and others. Even if the tools are locally operable, loss or damage to the tools or cables used to power and operate them remains a risk until the job is complete.

### SUMMARY OF THE INVENTION

In accordance with the present invention, there is provided a system for integrating welding and grinding operations. The system can include a motor-driven welder assembly coupled with a motor that is a power source for the welding device to perform a welding operation and a welding grinder including a handle portion and a grinding portion. The system can further include a grinder bay within the motor-driven welder assembly that stows the welding grinder within the motor-driven welder assembly, a a grinding power coupler that provides power from the motor to the welding grinder, and a grinder power cord that couples the welding grinder to the grinding power coupler.

Further in accordance with the present invention, there is provided a system including a hybrid welding system configured to receive power from a motor and a battery bank, a welding grinder configured to receive power through the hybrid welding system, and a welding grinder compartment of the hybrid welding system configured to store the welding grinder within the hybrid welding system.

An additional embodiment of a system can include a trailer incorporating a trailer hitch, a trailer frame, and a payload region and an adjustable stand on a front end of the trailer, wherein the adjustable stand is configured to adjust a height of the front end of the trailer. The system includes an engine driven welder secured to the payload region, a motor-driven welder assembly including a motor that is a power source for the engine driven welder to perform a welding operation, and a welding grinder system including at least a handle portion, a control portion, and a grinding portion. A first internal compartment houses the welding grinder system. There is also a grinder power supply that provides power for the grinder from the motor, a grinder cord that couples the welding grinder system to the grinder power supply, a grinder cord spool that stores the grinder cord, a grinder cord stop that prevents stress between a connection of the grinder cord and the grinder cord spool, and a second internal compartment at least partially partitioned from the first internal compartment that houses at least the cord spool.

These and other objects of this invention will be evident when viewed in light of the drawings, detailed description, and appended claims.

### BRIEF DESCRIPTION OF THE DRAWINGS

The above and/or other aspects of the invention will be more apparent by describing in detail exemplary embodiments of the invention with reference to the accompanying drawings

in which:

FIG. 1 is a diagram illustrating a welding device that includes a motor as a power source;

FIG. 2 is a diagram illustrating a welding device;

FIG. 3 is a diagram illustrating a welding device affixed to a trailer for mobility;

FIGS. 4A and 4B are diagrams illustrating a welding device;

FIG. 5 is a diagram of an embodiment of a welder with a built-in grinder;

FIGS. 6A and 6B illustrate embodiments including alternative positioning for a built-in grinder for a welder; and

FIGS. 7A and 7B illustrate embodiments of a built-in grinder with cutaway portions to depict various aspects of the built-in grinder apparatus.

### DETAILED DESCRIPTION

Embodiments of the invention will now be described below by reference to the attached figures. The described embodiments are intended to assist the understanding of the invention, and are not intended to limit the scope of the invention in any way. Like reference numerals refer to like elements throughout.

It is to be appreciated that a power source, as used herein, can be a motor, an engine, a generator, an energy storage device, a battery, a component that creates electrical power, a component that converts electrical power, or a combination thereof.

Aspects discussed herein are equally applicable to, and can be utilized in, systems and methods related to arc welding, laser welding, brazing, soldering, plasma cutting, waterjet cutting, laser cutting, and any other systems or methods using similar control methodology, without departing from the spirit or scope of the discussed inventions. The embodiments and discussions herein can be incorporated into any such systems and methodologies by those of skill in the art on review of the disclosures.

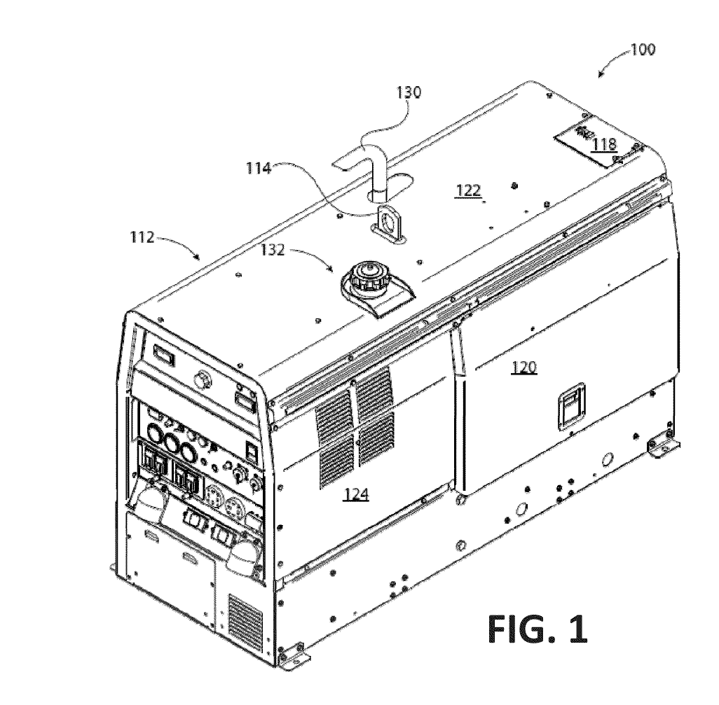

FIG. 1 illustrates a welding device 100. The welding device 100 includes a housing 112 which encloses the internal components of the welding device. Optionally, the welding type device 100 includes a loading eyehook 114 and/or fork recesses 116. The loading eyehook 114 and the fork recesses 116 facilitate the portability of the welding device 100. Optionally, the welding-type device 100 could include a handle and/or wheels as a means of device mobility. The housing 112 also includes a plurality of access panels 118, 120. Access panel 118 provides access to a top panel 122 of housing 112 while access panel 120 provides access to a side panel 124 of housing 112. A similar access panel is available on an opposite side. These access panels 118, 120, provide access to the internal components of the welding device 100 including, for example, an energy storage device (not shown) suitable for providing welding-type power. An end panel 126 includes a louvered opening 128 to allow for air flow through the housing 112.

The housing 112 of the welding-type device 100 also houses an internal combustion engine. The engine is evidenced by an exhaust port 130 and a fuel port 132 that protrude through the housing 112. The exhaust port 130 extends above the top panel 122 of the housing 112 and directs exhaust emissions away from the welding-type device 100. The fuel port 132 preferably does not extend beyond the top panel 122 or side panel 124. Such a construction protects the fuel port 132 from damage during transportation and operation of the welding-type device 100.

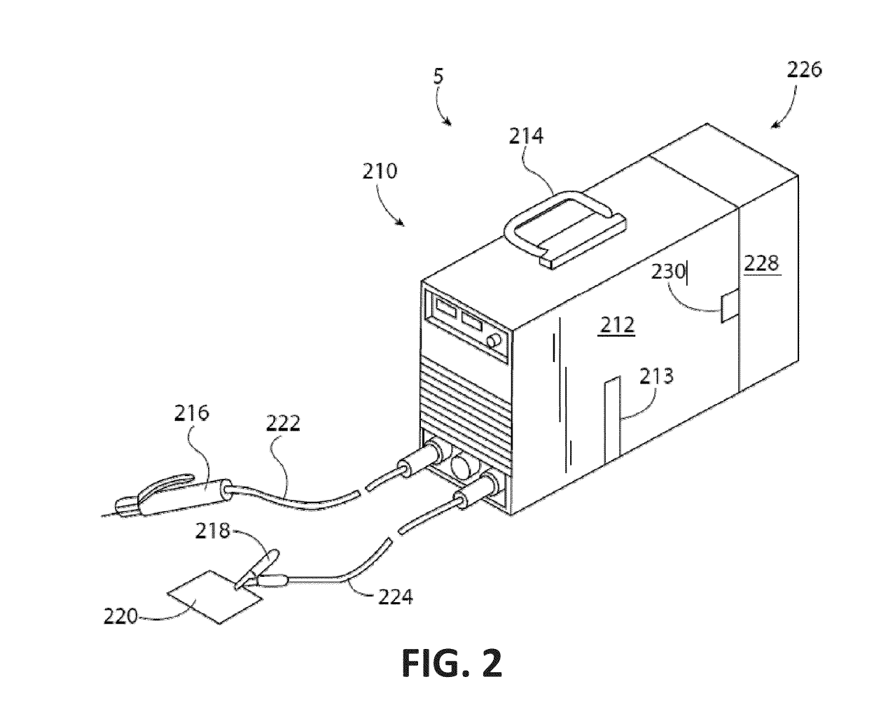

Referring now to FIG. 2, a perspective view of a welding apparatus 205 that can be utilized with the subject innovation. Welding apparatus 205 includes a power source 210 that includes a housing 212 enclosing the internal components of power source 210. As will be described in greater detail below, housing 212 encloses control components 213. Optionally, welding apparatus 205 includes a handle 214 for transporting the welding system from one location to another. To effectuate the welding process, welding apparatus 205 includes a torch 216 as well as a grounding clamp 218. Grounding clamp 218 is configured to ground a workpiece 220 to be welded. As is known, when torch 216 is in relative proximity to workpiece 220, a welding arc or cutting arc, depending upon the particular welding-type device, is produced. Connecting torch 216 and grounding clamp 218 to housing 212 is a pair of cables 222 and 224, respectively.

The welding arc or cutting arc is generated by the power source by conditioning raw power received from an interchangeable energy storage device 226. In a preferred embodiment, energy storage device 226 is a battery. Energy storage device 226 is interchangeable with similarly configured batteries. Specifically, energy storage device 226 is encased in a housing 228. Housing 228 is securable to the housing of welding apparatus 205 thereby forming welding-type apparatus 205. Specifically, energy storage device 226 is secured to power source 210 by way of a fastening means 230. It is contemplated that fastening means 230 may include a clip, locking tab, or other means to allow energy storage device 226 to be repeatedly secured and released from power source 210.

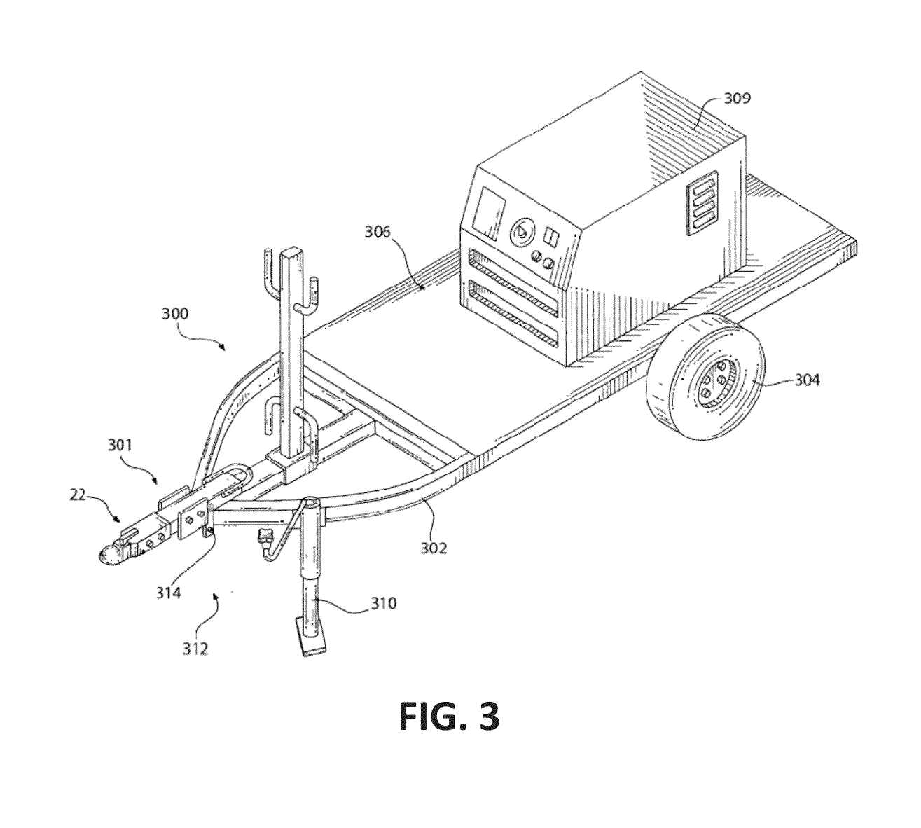

FIG. 3 illustrates a trailer 300 incorporating a trailer hitch or hitching device, depicted generally at 301. The trailer 300 may include a trailer frame 302 and one or more trailer wheels 304 in rotational connection with the trailer frame 302 and may further include a payload region 306 for carrying one or more cargo items, which in an exemplary manner may be a welding power supply 309 or an engine driven welding power supply 309. The trailer 300 may also include an adjustable stand 310 for adjusting the height of the front end 312 of the trailer 300. However, any means may be used for raising and/or lowering the front end 312 of the trailer 300. The trailer hitch 301 may be a generally longitudinal and substantially rigid trailer hitch 301 and may be attached to the frame 302 via fasteners 314, which may be threaded bolts.

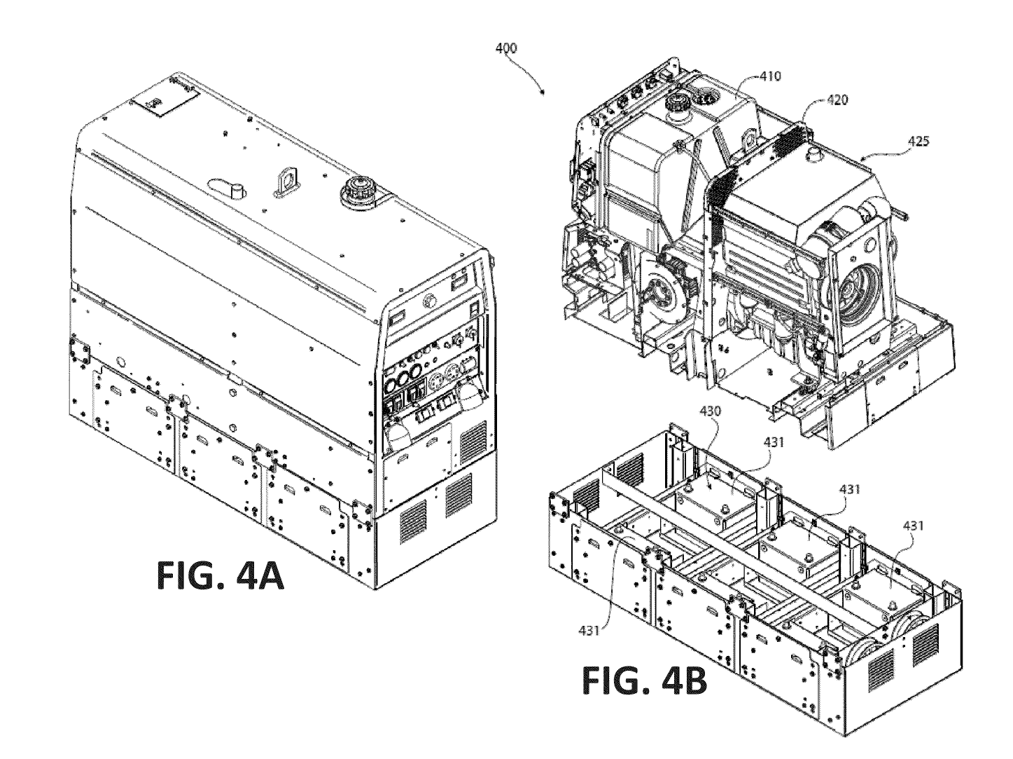

FIGS. 4A and 48 illustrate a hybrid welding device (herein referred to as a “hybrid welder”). A hybrid welder according to the invention is generally indicated by the number 400 in the drawings. Hybrid welder 400 includes an engine component that runs on fuel from fuel storage 410 allowing the hybrid welder 400 to be portable. It will be appreciated that hybrid welder 400 may also be mounted in a permanent location depending on the application. Hybrid welder 400 generally includes a motor-driven welder assembly 420 having a motor 425 and an energy storage device 430. Motor 425 may be an internal combustion engine operating on any known fuel including but not limited to gasoline, diesel, ethanol, natural gas, hydrogen, and the like. These examples are not limiting as other motors or fuels may be used.

The motor 425 and energy storage device 430 may be operated individually or in tandem to provide electricity for the welding operation and any auxiliary operations performed by hybrid welder 400. For example, individual operation may include operating the motor 425 and supplementing the power from the motor 425 with power from the energy storage device 430 on an as needed basis. Or supplying power from the energy storage device 430 alone when the motor 425 is offline. Tandem operation may also include combining power from motor 425 and energy storage device 430 to obtain a desired power output. According to one aspect of the invention, a welder 400 may be provided with a motor having less power output than ordinarily needed, and energy storage device 430 used to supplement the power output to raise it to the desired power output level. In an embodiment, a motor with no more than 19 kW (25 hp) output may be selected and supplemented with six 12 volt batteries. Other combinations of motor output may be used and supplemented with more or less power from energy storage device. The above example, therefore, is not limiting.

Energy storage device 430 may be any alternative power source including a secondary generator, kinetic energy recovery system, or, as shown, one or more batteries 431. In an embodiment, six 12 volt batteries 431 are wired in series to provide power in connection with motor-driven welder assembly 420. Batteries 431 shown are lead acid batteries. Other types of batteries may be used including but not limited to NiCd, molten salt, NiZn, NiMH, Li-ion, gel, dry cell, absorbed glass mat, and the like.

In embodiments, hybrid welder 400 can include a switch component for switching between power from motor 425 and energy storage device 430. In embodiments, switches can actuate one or both of motor 425 and energy storage device 430 simultaneously. In alternative or complementary embodiments, control circuitry can be used to effect switching manually or automatically.

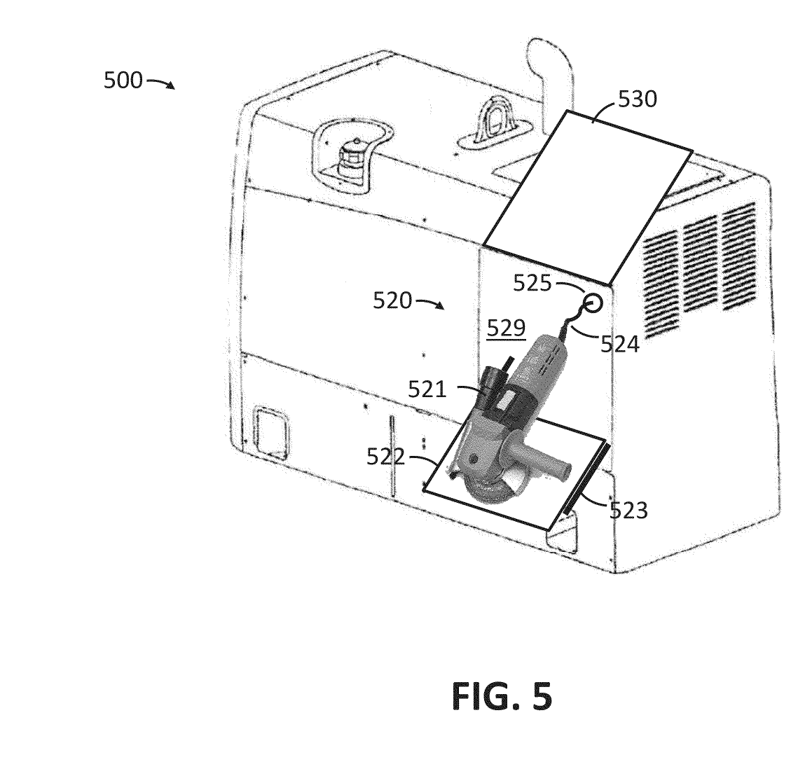

Embodiments for carrying out the invention will now be described for the purposes of illustrating the best mode known to the applicant at the time of the filing of this patent application. The examples and figures are illustrative only and not meant to limit the invention which is measured by the scope and spirit of the claims. Referring now to the drawings, wherein the showings are for the purpose of illustrating an exemplary embodiment of the invention only and not for the purpose of limiting same, FIGS. 5-8 illustrate a schematic block diagram of a welding device, and in particular, an engine driven welding device as discussed in FIGS. 1-4.

FIG. 5 shows an embodiment of a welder 500 including built-in grinder system 520. Built-in grinder system 520 includes grinder 521, which can be stowed in recess 529. Grinder 521 can include a handle portion and a grinding portion. In some embodiments, grinder 521 is detachable from built-in grinder system 520, in either a cord-tethered configuration or wholly wireless. In alternative embodiments, grinder 521 remains at least partially fixed to at least a portion of built-in grinder system 520. Grinder 521 can be a hand-held grinder, or include various restraints or assists to manage its motion and operation. The handle portion can be one or more portions designed for operator handling, and can include one or more controls (e.g., a trigger) to initiate or modify grinding operations. The grinding portion can include portions that contact the workpiece, as well as shields or other components designed to aid in ease of use or safety. In embodiments, at least a part of the grinding portion can be exchanged or swapped.

When grinder 521 is stowed in recess 529, access panel 530 can be closed. In embodiments, access panel 530 is flat, and creates a flush closure matching the contours of welder 500 when closed. In other embodiments, access panel 530 can be curved, 3-dimensional, or include a “jog-out”, increasing the closed volume of recess 529 to accommodate the specific geometry of grinder 521. In still other alternative embodiments, access panel 530 can include a hole that allows at least a portion of built-in grinder system 520 to protrude through access panel 530 when access panel 530 is in a closed state.

Grinder 521 is supported by base 522. In embodiments, base 522 can extend outward from recess 529 to permit easy access to grinder 521 and a secure resting position for grinder 521 when not in use. In embodiments where base 522 can extend outward using support system 523. Support system 523 can include drawer-like rails which telescope or nest when transitioning between an open or closed state. In embodiments, base 522 can be extended or retracted through other mechanisms (e.g., swinging out or in) and can be supported through other mechanisms (e.g., hinges, support cables, legs, stops). In embodiments, base 522 can be cantilevered when extended outward, and support system 523 does not extend beyond the outer edge of welder 500.

Grinder 521 is coupled with retractable cord 524. Retractable cord 524 provides electrical power to grinder 521 for operation. In embodiments, retractable cord 524 can be reinforced to resist damage (e.g., fraying, cutting) and permit use of retractable cord 524 as a tether for grinder 521. Retractable cord 524 can pass through cord aperture 525 to a compartment partitioned from recess 529 where the cord can be kept. Retractable cord 524 can have attached thereto a cord stop (not pictured in FIG. 5) that contacts cord aperture 525 or another component to prevent retractable cord 524 from being overextended, damaged, or disconnected from welder 500 or other coupled components.

While built-in grinder system 520 is shown oriented in a particular area of welder 500, those of skill in the art will appreciate how this orientation is for illustrative purposes only, and that the particular positioning illustrated is only one of many possible configurations under the disclosures here. Further, it is understood that some embodiments of welders may not permit integration of built-in grinder system 520, due to the location of internal components. Nonetheless, at least one embodiment of welder can be configured to integrate built-in grinder system 520 as illustrated, and FIG. 5 can provide illustrative detail for integration in other embodiments.

Further, while grinder 521 is shown with retractable cord 524, it is understood that, in alternative embodiments, retractable cord 524 need not be a component of built-in grinder system 520, and grinder 521 can be a cordless grinder with a self-contained battery. In some such embodiments, grinder 521 can include a recharging port that mates with a similar port in base 522. In this way, the self-contained battery of a cordless grinder 521 can be recharged using power from welder 500.

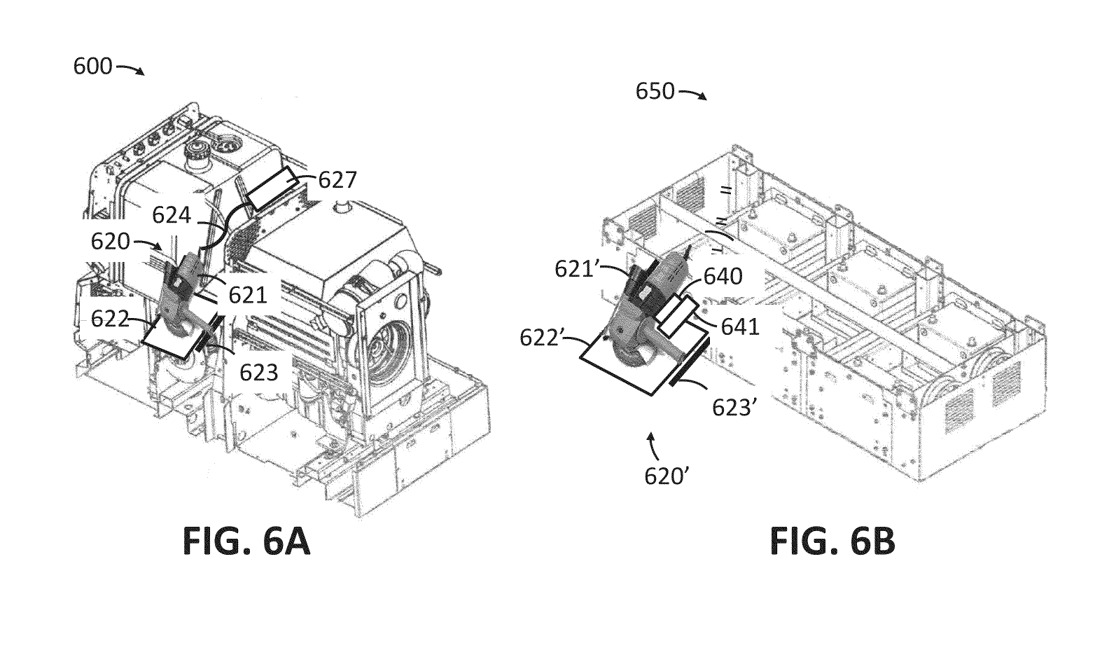

FIGS. 6A and 6B illustrate embodiments of possible placements of a built-in grinder in relation to various welding components. FIG. 6A illustrates a hybrid welder 600 with its outer case removed, and FIG. 6B shows an energy storage apparatus 650 for use with hybrid welder 600.

While FIGS. 6A and 6B depict built-in grinding systems 620 and 620′, respectively, it is understood that when hybrid welder 600 and energy storage apparatus 650 are used in conjunction, only one of grinding systems 620 and 620′ will be included. Thus, in some embodiments of a hybrid welding system using hybrid welder 600 and energy storage apparatus 650, only one of built-in grinding system 620 and built-in grinding system 620′ will be present. Nonetheless, alternative embodiments can include two or more of built-in grinding system 620, built-in grinding system 620′, and another tool integrated in a fashion similar to one of built-in grinding systems 620 and 620′.

FIG. 6A shows hybrid welder 600 decoupled from energy storage apparatus 650 with its motor and fuel storage exposed. Built-in grinding system 620 can be integrated in a void between the motor and fuel storage, or in another position. As illustrated between motor and fuel storage, built-in grinding system 620 can be surrounded by or include heat-resistant materials intended to insulate the grinder from motor heat, or conduct heat away from the built-in grinding system 620.

Built-in grinding system 620 can include grinder 621, base 622, and base supports 623. Base 622 may extend out of or retract into the space between the motor and fuel storage to improve access to grinder 621 and/or provide a “table” on which to replace grinder 621. Base 622 can be supported or retained in one or both of extended and retracted positions by base supports 623.

Grinder 621 is powered using electricity provided through retractable cord 624. Retractable cord 624 is stored about cord spool 627, which can be manually wound to spool or unspool retractable cord 624, or be biased (e.g., spring-loaded) to automatically spool slack in retractable cord 624. In embodiments, retractable cord 624 need not pass through a cord aperture, and cord spool 627 can be disposed in a position with no physical separation from other components of built-in grinding system 620.

FIG. 6B shows energy storage apparatus 650 (e.g., battery bank) having built-in grinding system 620′. Built-in grinding system 620′ includes cordless grinder 621′. Cordless grinder 621′ includes grinder charging port 640, which is configured to couple with base charging port 641 on base 622′. In this way, an internal battery for cordless grinder 621′ can be recharged when cordless grinder 621′ is on base 622′. Base 622′ can be restrained or moved about by way of base supports 623′. In some embodiments, built-in grinding system 620′ can be placed in a space which may otherwise house a battery or other portion of energy storage apparatus 650.

Bases 622 and 622′ can include strap, clip, retainer, or other securing member (not pictured) to secure grinder 621/621′ when engaged. When a securing member is engaged, hybrid welder 600 and/or energy storage apparatus 650 can be moved without shifting of grinder 621/621′, and grinder 621/621′ is secure and prevented from falling off base 622/622′.

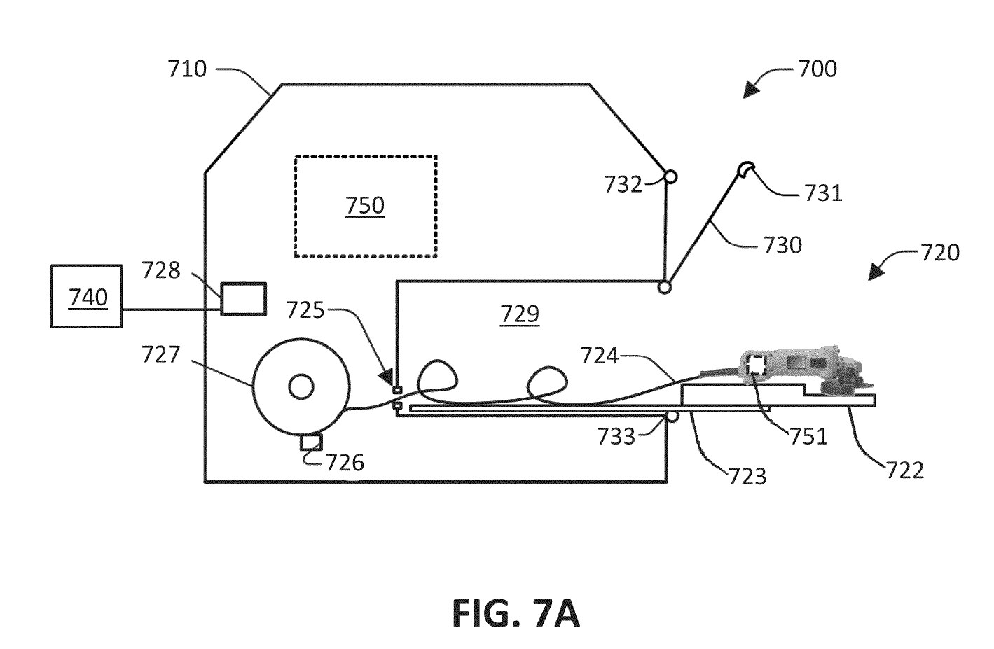

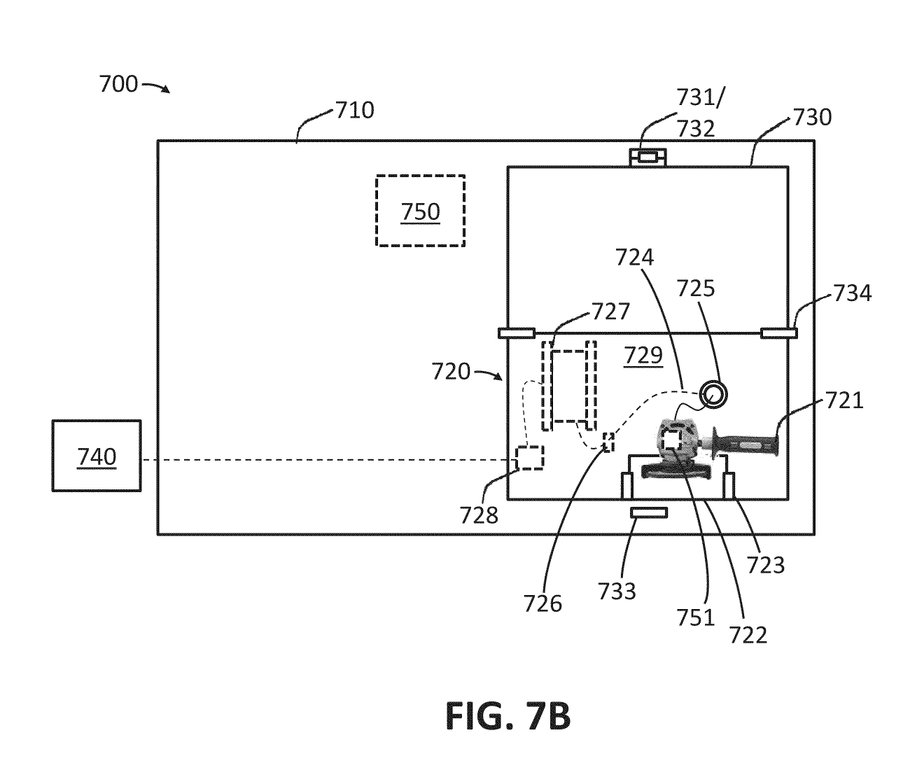

FIGS. 7A and 7B illustrate cutaway views of welding system 700 incorporating built-in grinder system 720. Welding system 700 includes engine-driven welder 710, which is operatively coupled to engine 740. Engine 740 is used to generate at least a portion of power utilized by engine driven welder 710.

In addition to components utilized with welding tools, engine driven welder 710 includes grinder opening 729 (or grinder bay), which stores grinder 721 and associated components. Grinder opening 729 is exposed or enclosed depending on the position of grinder door 730. Grinder door 730 can be hingedly attached or fold in an outward or inward direction. In embodiments, grinder door 730 can slide along rails to be opened outside engine driven welder 710, or can slide into a compartment of engine driven welder 710. In hinged and sliding embodiments, grinder door 730 may include multiple partitions (e.g., hingedly connected) that allow the door to assume curvature otherwise change its shape during opening or closing. Grinder door 730 can include door lock 731, which can attach to one of grinder locks 732 and 733 to secure grinder door 730 in an open or closed position. In some embodiments, door lock 731 can include a lock to provide security and prevent unauthorized use or removal of grinder 721.

Grinder 721 is electrically powered by retractable cord 724. Retractable cord 724 passes through a partition via cord aperture 725, whereafter spool 727 (or another cord-retention component) retains excess cord not needed to move the grinder to a position where it is utilized. Retractable cord 724 can be used in combination with overextension preventer 726, which is fixed to at least one portion of retractable cord 724 and stops in contact with cord aperture 725 or another component to prevent retractable cord 724 from being overextended and separating from spool 727 or power coupler 728. Positions or locations where overextension would strain or damage the connections of retractable cord 724 can be referred to as maximum extension positions. A distal cord end operatively attaches with power coupler 728, which routes appropriate electrical power to retractable cord 724 to power grinder 721. In embodiments, power coupler 728 can include a converter, inverter, fuse, surge protector, or other components that prevent excess electrical power from being routed to and possibly damaging grinder 721.

Grinder 721 can rest on base 722. As shown in at least FIG. 7A, base 722 includes at least a stowed position and a usage position. Base 722 can slide, roll, or otherwise be moved out of grinder opening 729 to improve access and function of built-in grinder system 720. Base tracks 723 can support base 722 in one or both of the stowed position and usage position. In some embodiments, base 722 can be machined, molded, or otherwise shaped to accommodate grinder 721 placed on base 722 in one or more positions.

In some embodiments, grinder 721 can be associated with control module 750. Control module 750 can send control signals to grinder controller 751 to provide grinding parameters for operations. For example, a particular grinding operation can be optimized using a particular range of speeds (e.g., 500-700 rotations per minute). In embodiments, control module 750 can provide a signal to grinder controller 751 that limits grinder 721 speeds to the identified range. Other parameters can include power (e.g., power level), torque, braking, automatic shutoff, et cetera. Control module 750 and grinder controller 751 can communicate by wired or wireless techniques. In embodiments control module 750 may be communicatively connected to retractable cord 724, and may use retractable cord 724 to send or receive signals with grinder controller 751. In specific embodiments, retractable cord 724 can be a combined cable including both a power cable for carrying electrical power and a communication cable for carrying information between components. In at least one embodiment, control module 750 and grinder controller 751 are a single component.

In some embodiments, control module 750 can select a grinder power supply and/or modify a grinder power parameter. For example, power received through power coupler 728 can be, prior to actuation of grinder 721, power configured to support welding or another operation having different requirements or constraints than those of grinder 721. Upon action related to grinder 721 (e.g., actuation by trigger, removal from base 722, extension of retractable cord 724, movement of base 722 with reference to base supports 723, opening of grinder door 730), control module 750 can check the status of power being supplied to engine-driven welder 710 and via power coupler 728 to ensure supplied power is compatible (e.g., voltage, alternating or direct current, current level, polarity) with grinder 721. Alternatively, action related to grinder 721 can automatically toggle to an appropriate power setting. Further, in embodiments where multiple energy sources are available (e.g., engine-driven welder with hybrid battery capability) control module 750 can evaluate the stability and longevity of power sources to select which to employ (e.g., prefer engine 740 when available, switch from batteries when levels low, prioritize welder user of electricity) when operating grinder 721.

While embodiments discussed herein have been related to the systems and methods discussed above, these embodiments are intended to be exemplary and are not intended to limit the applicability of these embodiments to only those discussions set forth herein. The control systems and methodologies discussed herein are equally applicable to, and can be utilized in, systems and methods related to arc welding, laser welding, brazing, soldering, plasma cutting, waterjet cutting, laser cutting, and any other systems or methods using similar control methodology, without departing from the spirit of scope of the above discussed inventions. The embodiments and discussions herein can be readily incorporated into any of these systems and methodologies by those of skill in the art. By way of example and not limitation, a power supply as used herein (e.g., welding power supply, among others) can be a power supply for a device that performs welding, arc welding, laser welding, brazing, soldering, plasma cutting, waterjet cutting, laser cutting, among others. Thus, one of sound engineering and judgment can choose power supplies other than a welding power supply departing from the intended scope of coverage of the embodiments of the subject invention. Other variations, related and unrelated to those briefly described above, will be understood by those of skill in the art upon review of the disclosures herein.

What is claimed is:

1. A welding device, comprising:
a motor-driven welder assembly coupled with a motor that is a power source for the welding device to perform a welding operation;
a welding grinder including a handle portion and a grinding portion;
a grinder bay within the motor-driven welder assembly that stows the welding grinder within the motor-driven welder assembly;
a grinding power coupler that provides power from the motor to the welding grinder; and
a grinder power cord that couples the welding grinder to the grinding power coupler.

2. The welding device of claim 1, further comprising:
an access panel that covers at least a portion of the grinder bay in a closed position, the access panel blocks access to the welding grinder in a closed position,
wherein the access panel is substantially flush with an exterior contour of the motor-driven welder assembly in a closed position.

3. The welding device of claim 2, further comprising one or more access panel locks that secure the access panel in at least one position.

4. The welding device of claim 1, further comprising:
an energy storage device that is an additional power source for at least one of the welding device and the grinder.

5. The welding device of claim 4, wherein the energy storage device is a battery bank.

6. The welding device of claim 4, further comprising:
a switch component that selects between the energy storage device and the motor.

7. The welding device of claim 4, wherein the welding grinder receives a portion of power from the energy storage device to conduct a grinding operation.

8. The welding device of claim 7, wherein the welding grinder is powered by the motor or the energy storage device.

9. The welding device of claim 1, wherein the grinder power coupler converts an electric energy from at least the motor power source to a form usable by the welding grinder.

10. The welding device of claim 1, further comprising a grinder power cord spool that winds the grinder power cord when not in use.

11. The welding device of claim 1, further comprising a grinder power cord overextension preventer that stops motion of the grinder power cord at a maximum extension position.

12. The welding device of claim 1, further comprising a control module that provides a grinding parameter to the welding grinder using a control signal.

13. The welding device of claim 12, wherein the grinding parameter is one or more ranges of power, torque, or braking.

14. The welding device of claim 12, wherein the grinding parameter is a shutoff condition.

15. A system, comprising:
a hybrid welding system configured to receive power from a motor and a battery bank;
a welding grinder configured to receive power through the hybrid welding system; and
a welding grinder compartment of the hybrid welding system configured to store the welding grinder within the hybrid welding system.

16. The system of claim 15, further comprising a combined grinder cable configured to establish electrical communication between the hybrid welding system and the welding grinder.

17. The system of claim 16, wherein the combined grinder cable carries electrical power to the welding grinder.

18. The system of claim 16, further comprising a grinder controller configured to impose a grinding parameter on the grinder based on a grinder control signal.

19. The system of claim 18, wherein the combined grinder cable carries the grinder control signal to the welding grinder.

20. A system, comprising:
a trailer incorporating a trailer hitch, a trailer frame, and a payload region;
an adjustable stand on a front end of the trailer, wherein the adjustable stand is configured to adjust a height of the front end of the trailer;
an engine driven welder secured to the payload region;
a motor-driven welder assembly including a motor that is a power source for the engine driven welder to perform a welding operation;
a welding grinder system including at least a handle portion, a control portion, and a grinding portion;
a first internal compartment that houses the welding grinder system;
a grinder power supply that provides power for the grinder from the motor;
a grinder cord that couples the welding grinder system to the grinder power supply;
a grinder cord spool that stores the grinder cord;
a grinder cord stop that prevents stress between a connection of the grinder cord and the grinder cord spool; and
a second internal compartment at least partially partitioned from the first internal compartment that houses at least the cord spool.
